(19) United States
(12) Patent Application Publication
(10) Pub. No.: US 2025/0047737 A1
(43) Pub. Date: Feb. 6, 2025

(54) USING AN EDGE REPOSITORY

(71) Applicant: QUALCOMM Incorporated, San Diego, CA (US)

(72) Inventors: Nishant GUPTA, Bangalore (IN); Alan SOLOWAY, Frederick, CO (US); Sunghoon KIM, San Diego, CA (US); Dario Serafino TONESI, San Diego, CA (US); Tom CHIN, San Diego, CA (US); Ajith Tom PAYYAPPILLY, San Diego, CA (US)

(21) Appl. No.: 18/716,426

(22) PCT Filed: Dec. 23, 2022
(86) PCT No.: PCT/US2022/082337

§ 371 Date: Jun. 4, 2024

(30) Foreign Application Priority Data
Feb. 8, 2022 (IN) 202241006745

(51) Int. Cl. H04L 67/10; H04L 67/51

(52) U.S. Cl. CPC H04L 67/10; H04L 67/51

(57) ABSTRACT

Various aspects of the present disclosure generally relate to wireless communication. In some aspects, an edge repository may receive, from at least one first edge configuration server (ECS) associated with an operator of the edge repository, first information associated with edge computing resources associated with the at least one first ECS. Additionally, the edge repository may receive, from at least one additional edge repository, associated with at least one additional operator, second information associated with edge computing resources associated with at least one second ECS. Accordingly, the edge repository may transmit, to the at least one first ECS, the first information, the second information, or a combination thereof. Additionally, the edge repository may transmit, to the at least one additional edge repository associated with at least one additional operator, the first information. Numerous other aspects are described.

### CROSS-REFERENCE TO RELATED APPLICATION

This Patent Application claims priority to Indian Provisional Patent Application No. 202241006745, filed on Feb. 8, 2022, entitled “USING AN EDGE REPOSITORY,” and assigned to the assignee hereof. The disclosure of the prior Application is considered part of and is incorporated by reference in this Patent Application.

### FIELD OF THE DISCLOSURE

Aspects of the present disclosure generally relate to wireless communication and to techniques and apparatuses for using an edge repository.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at an edge repository. The apparatus may include a memory and one or more processors coupled to the memory. The one or more processors may be configured to receive, from at least one first edge configuration server (ECS) associated with an operator of the edge repository, first information associated with edge computing resources associated with the at least one first ECS. The one or more processors may be configured to receive, from at least one additional edge repository, associated with at least one additional operator, second information associated with edge computing resources associated with at least one second ECS. The one or more processors may be configured to transmit, to the at least one first ECS, the first information, the second information, or a combination thereof.

Some aspects described herein relate to an apparatus for wireless communication at an ECS. The apparatus may include a memory and one or more processors coupled to the memory. The one or more processors may be configured to transmit, to an edge repository associated with an operator, a registration request including information associated with edge computing resources associated with the ECS. The one or more processors may be configured to receive, from the edge repository, a response to the registration request.

Some aspects described herein relate to an apparatus for wireless communication at an edge enabler client (EEC). The apparatus may include a memory and one or more processors coupled to the memory. The one or more processors may be configured to transmit, to a primary ECS, a service provisioning request. The one or more processors may be configured to receive, from the primary ECS, information associated with one or more partner ECSs associated with one or more applications indicated by the service provisioning request. In some aspects, a “primary ECS” may also be referred to as a “configured ECS,” a “registrar ECS,” an “edge computing service provider's ECS” (“ECSP's ECS”), or a “leading ECS,” among other examples.

Some aspects described herein relate to a method of wireless communication performed by an edge repository. The method may include receiving, from at least one first ECS associated with an operator of the edge repository, first information associated with edge computing resources associated with the at least one first ECS. The method may include receiving, from at least one additional edge repository, associated with at least one additional operator, second information associated with edge computing resources associated with at least one second ECS. The method may include transmitting, to the at least one first ECS, the first information, the second information, or a combination thereof.

Some aspects described herein relate to a method of wireless communication performed by an ECS. The method may include transmitting, to an edge repository associated with an operator, a registration request including information associated with edge computing resources associated with the ECS. The method may include receiving, from the edge repository, a response to the registration request.

Some aspects described herein relate to a method of wireless communication performed by an EEC. The method may include transmitting, to a primary ECS, a service provisioning request. The method may include receiving, from the primary ECS, information associated with one or more partner ECSs associated with one or more applications indicated by the service provisioning request.

Some aspects described herein relate to a non-transitory computer-readable medium that stores a set of instructions for wireless communication by an edge repository. The set of instructions, when executed by one or more processors of the edge repository, may cause the edge repository to receive, from at least one first ECS associated with an operator of the edge repository, first information associated with edge computing resources associated with the at least one first ECS. The set of instructions, when executed by one or more processors of the edge repository, may cause the edge repository to receive, from at least one additional edge repository, associated with at least one additional operator, second information associated with edge computing resources associated with at least one second ECS. The set of instructions, when executed by one or more processors of the edge repository, may cause the edge repository to transmit, to the at least one first ECS, the first information, the second information, or a combination thereof.

Some aspects described herein relate to a non-transitory computer-readable medium that stores a set of instructions for wireless communication by an ECS. The set of instructions, when executed by one or more processors of the ECS, may cause the ECS to transmit, to an edge repository associated with an operator, a registration request including information associated with edge computing resources associated with the ECS. The set of instructions, when executed by one or more processors of the ECS, may cause the ECS to receive, from the edge repository, a response to the registration request.

Some aspects described herein relate to a non-transitory computer-readable medium that stores a set of instructions for wireless communication by an EEC. The set of instructions, when executed by one or more processors of the EEC, may cause the EEC to transmit, to a primary ECS, a service provisioning request. The set of instructions, when executed by one or more processors of the EEC, may cause the EEC to receive, from the primary ECS, information associated with one or more partner ECSs associated with one or more applications indicated by the service provisioning request.

Some aspects described herein relate to an apparatus for wireless communication. The apparatus may include means for receiving, from at least one first ECS associated with an operator of the apparatus, first information associated with edge computing resources associated with the at least one first ECS. The apparatus may include means for receiving, from at least one edge repository, associated with at least one additional operator, second information associated with edge computing resources associated with at least one second ECS. The apparatus may include means for transmitting, to the at least one first ECS, the first information, the second information, or a combination thereof.

Some aspects described herein relate to an apparatus for wireless communication. The apparatus may include means for transmitting, to an edge repository associated with an operator, a registration request including information associated with edge computing resources associated with the apparatus. The apparatus may include means for receiving, from the edge repository, a response to the registration request.

Some aspects described herein relate to an apparatus for wireless communication. The apparatus may include means for transmitting, to a primary ECS, a service provisioning request. The apparatus may include means for receiving, from the primary ECS, information associated with one or more partner ECSs associated with one or more applications indicated by the service provisioning request.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example of edge computing architecture, in accordance with the present disclosure.

FIGS. 4A, 4B, and 4C are diagrams illustrating examples of federation and/or roaming, in accordance with the present disclosure.

FIG. 5 is a diagram illustrating an example associated with an edge repository in edge computing architecture, in accordance with the present disclosure.

FIGS. 6, 7, 8, and 9 are diagrams illustrating examples associated with using an edge repository, in accordance with the present disclosure.

FIGS. 10, 11, and 12 are diagrams illustrating example processes associated with using an edge repository, in accordance with the present disclosure.

FIGS. 13, 14, and 15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

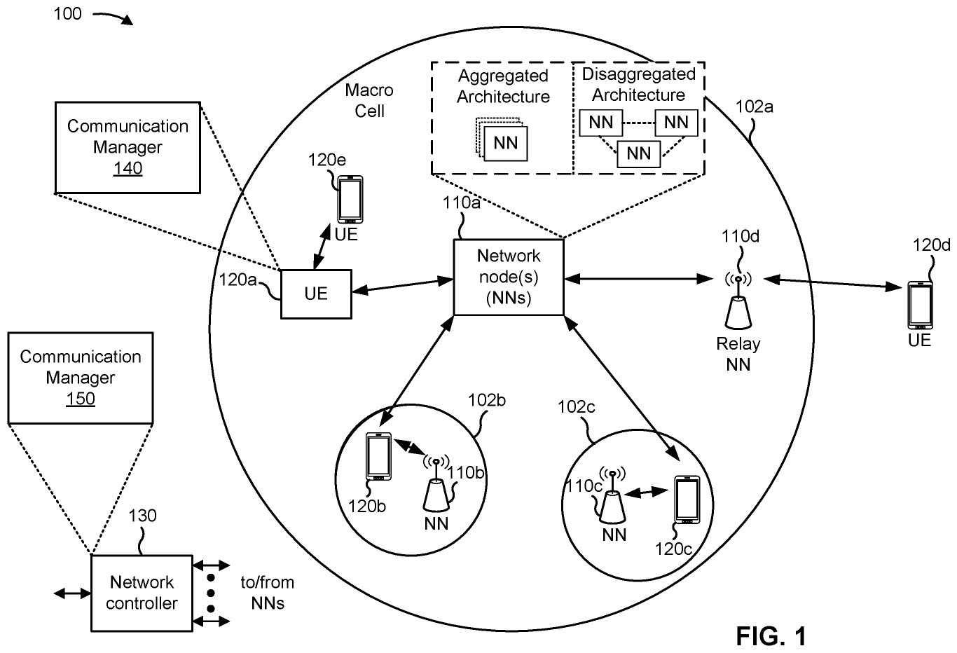

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network controller 130 may include an edge repository with a communication manager 150. As described in more detail elsewhere herein, the communication manager 150 may receive, from at least one first edge configuration server (ECS) associated with an operator of the edge repository, first information associated with edge computing resources associated with the at least one first ECS; receive, from at least one additional edge repository, associated with at least one additional operator, second information associated with edge computing resources associated with at least one second ECS; and transmit, to the at least one first ECS, the first information, the second information, or a combination thereof. Additionally, or alternatively, the network controller 130 may include an ECS with a communication manager 150. Accordingly, as described elsewhere herein, the communication manager 150 may transmit, to an edge repository associated with an operator, a registration request including information associated with edge computing resources associated with the ECS; and receive, from the edge repository, a response to the registration request. Additionally, or alternatively, the communication manager 150 may perform one or more other operations described herein.

In some aspects, the UE 120 may include an edge enabler client (EEC) with a communication manager 140. As described in more detail elsewhere herein, the communication manager 140 may transmit, to a primary ECS, a service provisioning request; and receive, from the primary ECS, information associated with one or more partner ECSs associated with one or more applications indicated by the service provisioning request. Additionally, or alternatively, the communication manager 140 may perform one or more other operations described herein.

As indicated above, FIG. 1 is provided as an example. Other examples may differ from what is described with regard to FIG. 1.

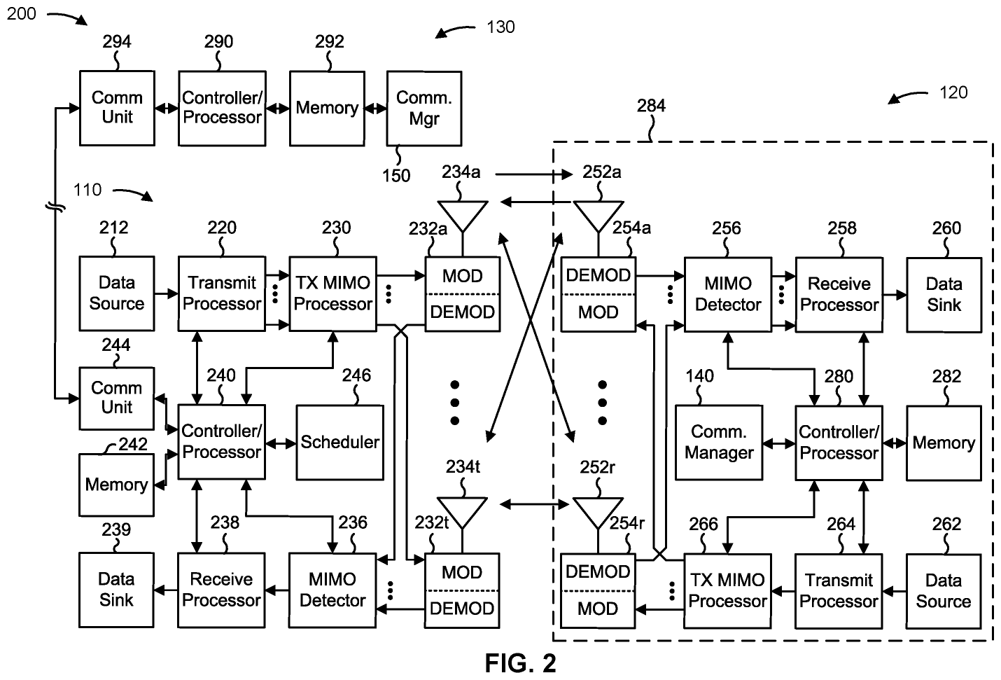

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

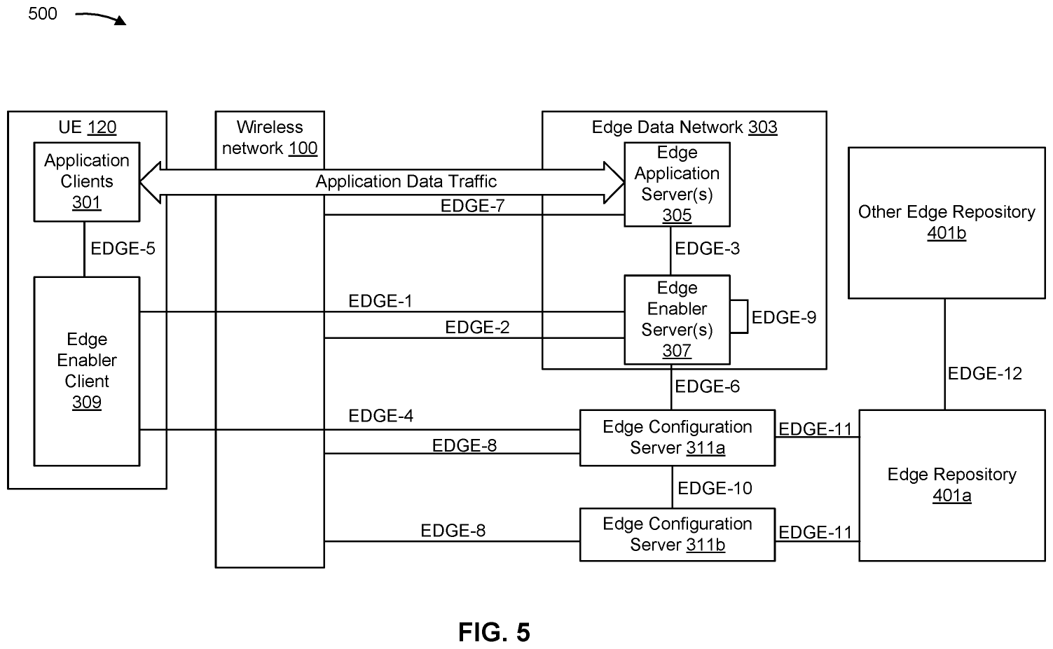

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

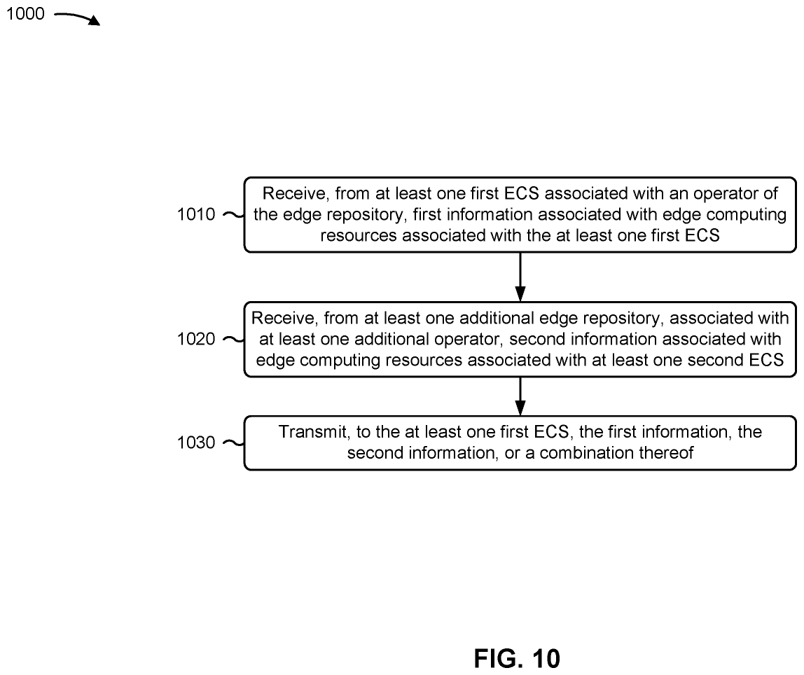

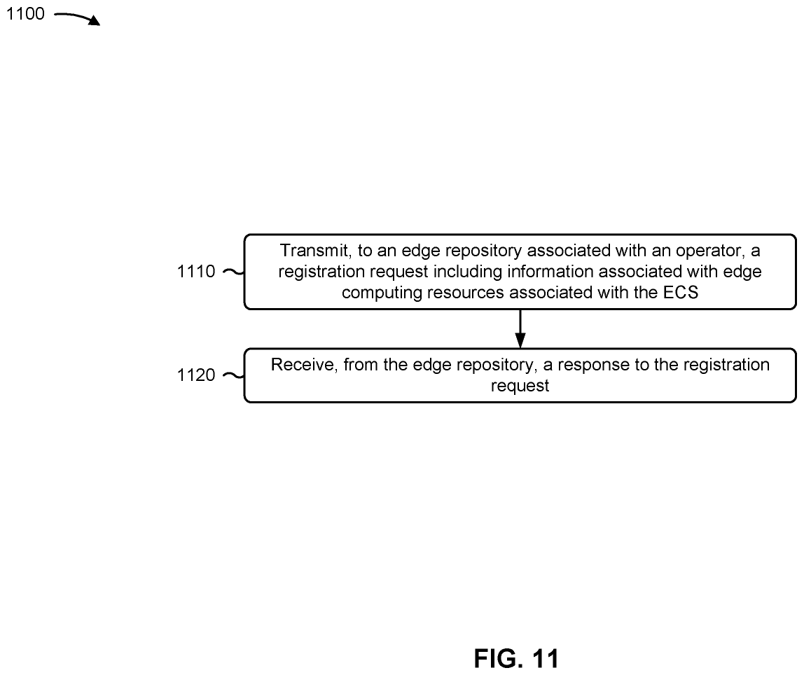

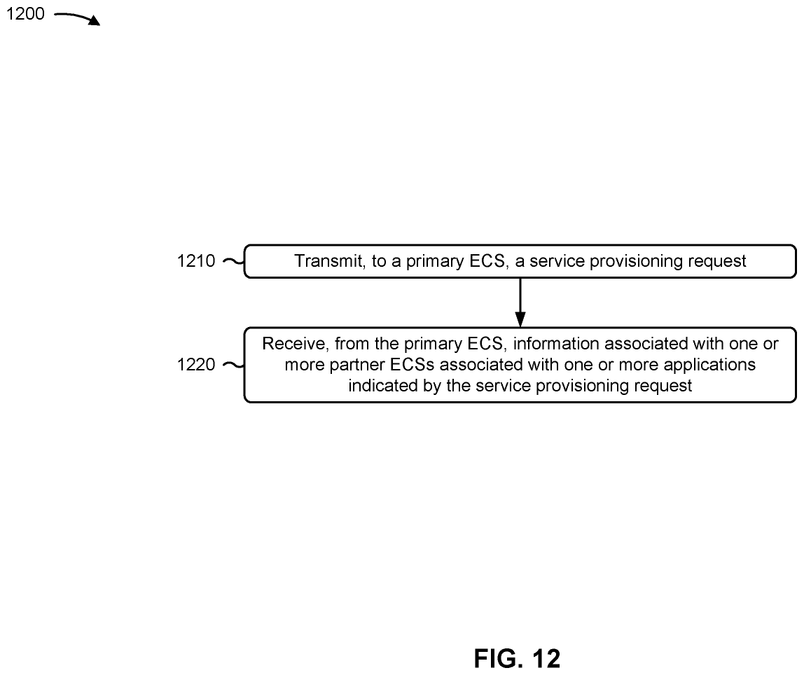

The controller/processor 240 of the network node 110, the controller/processor 280 of the UE 120, and/or any other component(s) of FIG. 2 may perform one or more techniques associated with using an edge repository, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples. In some aspects, the EEC described herein is the UE 120, is included in the UE 120, or includes one or more components of the UE 120 shown in FIG. 2. In some aspects, the edge repository and/or the ECS described herein is the network controller 130, is included in the network controller 130, or includes one or more components of the network controller 130 shown in FIG. 2.

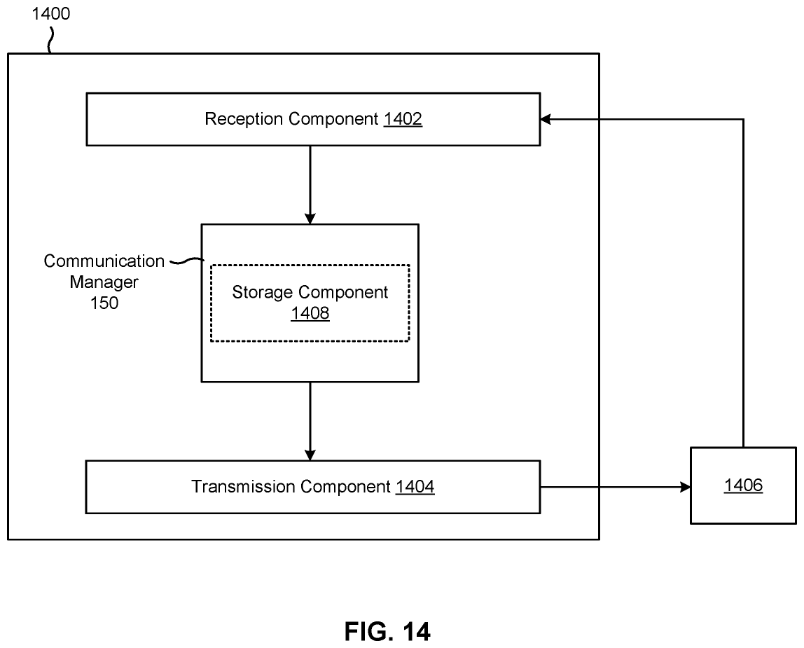

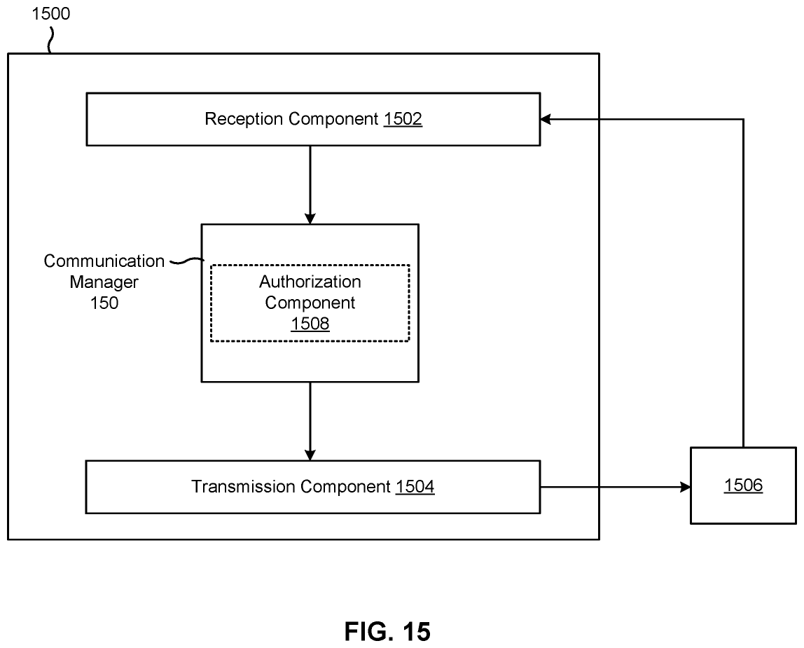

In some aspects, an edge repository (e.g., network controller 130 and/or apparatus 1400 of FIG. 14) may include means for receiving, from at least one first ECS (e.g., apparatus 1500 of FIG. 15) associated with an operator of the edge repository, first information associated with edge computing resources associated with the at least one first ECS; means for receiving, from at least one additional edge repository, associated with at least one additional operator, second information associated with edge computing resources associated with at least one second ECS; and/or means for transmitting, to the at least one first ECS, the first information, the second information, or a combination thereof. In some aspects, the means for the edge repository to perform operations described herein may include, for example, one or more of communication manager 150, controller/processor 290, memory 292, or communication unit 294.

In some aspects, an ECS (e.g., network controller 130 and/or apparatus 1500 of FIG. 15) may include means for transmitting, to an edge repository (e.g., apparatus 1400 of FIG. 14) associated with an operator, a registration request including information associated with edge computing resources associated with the ECS; and/or means for receiving, from the edge repository, a response to the registration request. In some aspects, the means for the ECS to perform operations described herein may include, for example, one or more of communication manager 150, controller/processor 290, memory 292, or communication unit 294.

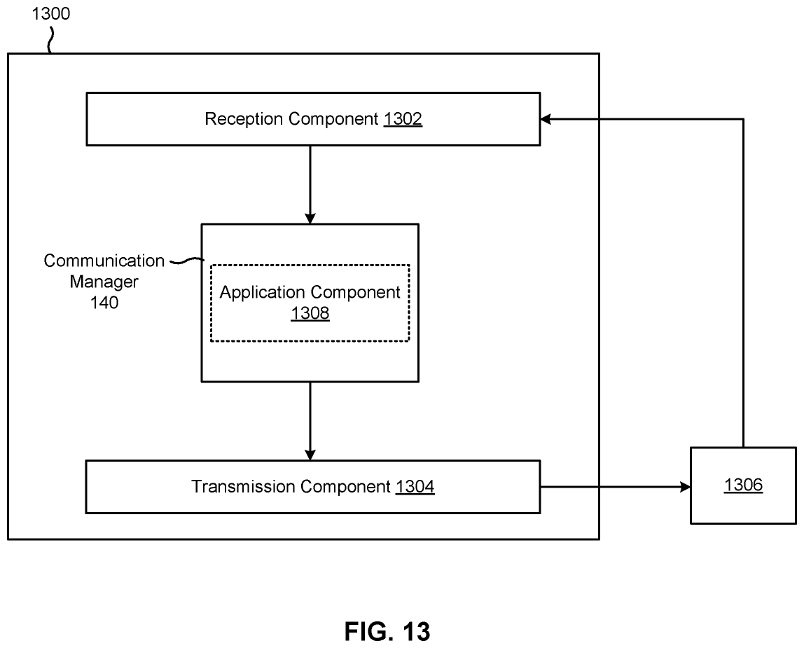

In some aspects, an EEC (e.g., UE 120 and/or apparatus 1300 of FIG. 13) includes means for transmitting, to a primary ECS (e.g., network controller 130 and/or apparatus 1500 of FIG. 15), a service provisioning request; and/or means for receiving, from the primary ECS, information associated with one or more partner ECSs associated with one or more applications indicated by the service provisioning request. In some aspects, the means for the EEC to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

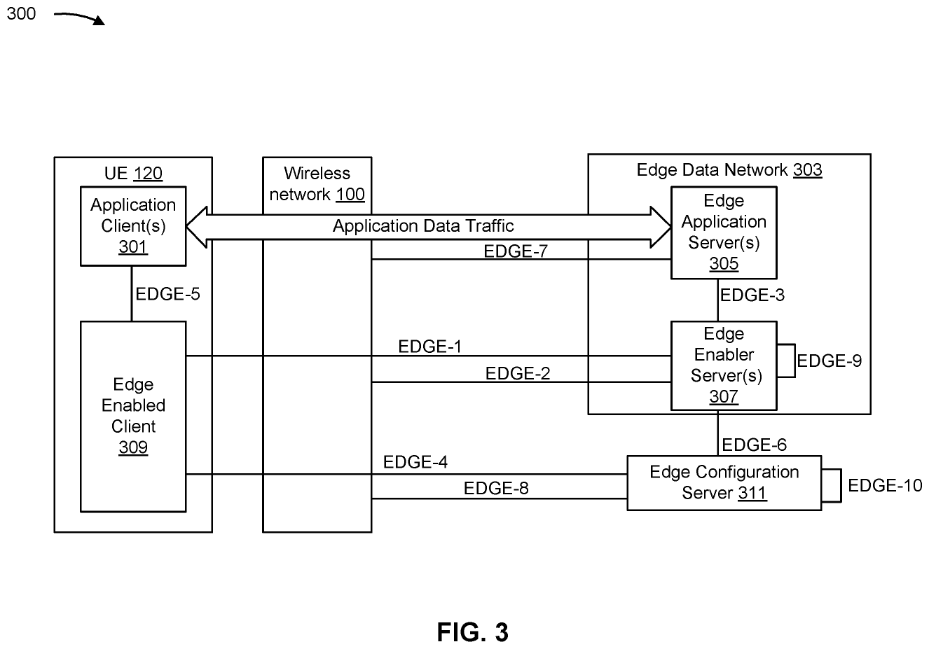

FIG. 3 is a diagram illustrating an example 300 of edge computing architecture, in accordance with the present disclosure. As shown in FIG. 3, example 300 includes a UE 120 communicating with a wireless network 100. The UE 120 may execute one or more applications (e.g., application client(s) 301) that are configured to use edge computing resources. By using the edge computing resources, the application client(s) experience reduced latency because the edge computing resources are deployed within, or adjacent to, a core network supporting the wireless network 100.

For example, as shown in FIG. 3, the edge computing resources may be provided from an edge data network (EDN) 303 and by one or more edge application servers 305 within the EDN 303. Additionally, the EASs may communicate with the wireless network 100 using an EDGE-7 interface.

The edge application server(s) 305 may provide the edge computing resources at the request of one or more edge enabler servers (EESs) 307. The EESs may communicate with each other using an EDGE-9 interface. Additionally, the EESs may communicate with the wireless network 100 using an EDGE-2 interface.

In order to request the edge computing resources, the application client(s) 301 may communicate with an edge enable client (EEC) 309 (e.g., executed by the UE 120) via an EDGE-5 interface. Accordingly, the EEC 309 may request the edge computing resources from the edge application server(s) 305 via the EES 307 (e.g., using an EDGE-1 interface).

However, in order to determine which EES 307 to use, the EEC 309 may contact one or more edge configuration servers 311 via an EDGE-4 interface. The ECS(s) 311 may communicate with each other using an EDGE-10 interface. The ECS(s) 311 may store information associated with the EDNs available to the EEC 309 and may also provide authorization of the EEC 309 to the EES 307 via an EDGE-6 interface. The ECS(s) 311 may additionally communicate with the wireless network 100 using an EDGE-8 interface.

As indicated above, FIG. 3 is provided as an example. Other examples may differ from what is described with respect to FIG. 3.

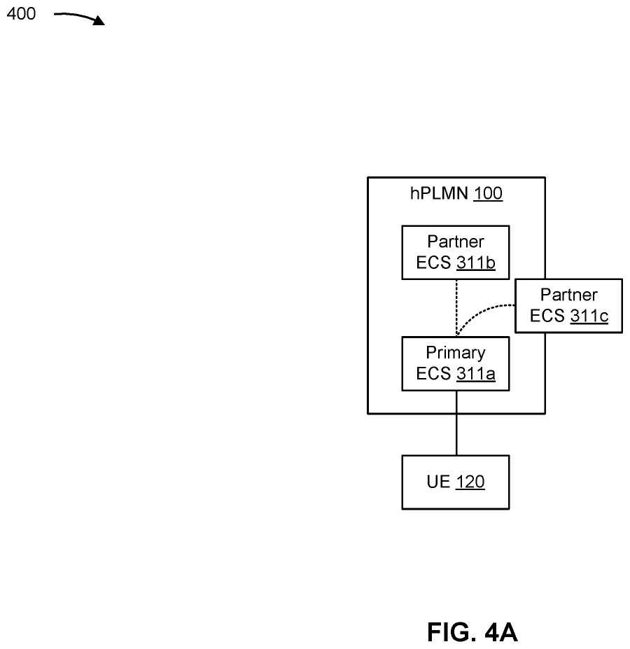

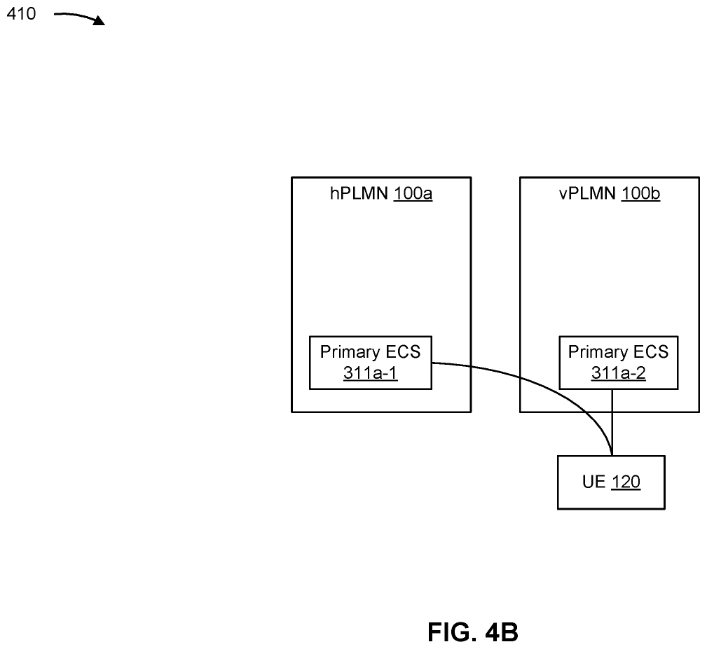

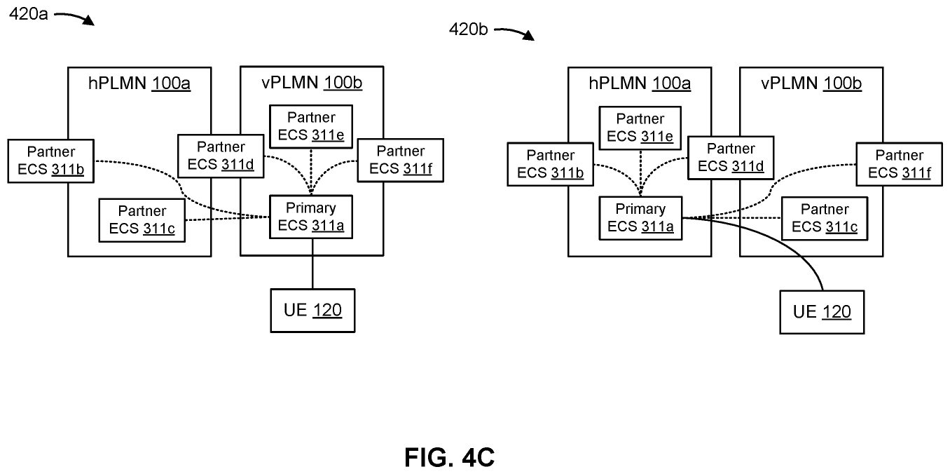

FIGS. 4A, 4B, and 4C are diagrams, illustrating examples 400, 410, and 420 (420a and 420b), respectively, of federation and/or roaming, in accordance with the present disclosure. In example 400, a UE 120 contacts a primary ECS 311a within a wireless network 100, where the wireless network 100 is a home network for the UE 120 (e.g., a home public land mobile network (PLMN) or hPLMN). As further shown in FIG. 4A, the primary ECS 311a is configured to receive information associated with partner ECSs (e.g., partner ECS 311b within the hPLMN, partner ECS 311c at least partially within the hPLMN, and/or another partner ECS outside the hPLMN) and provide the information to an EEC of the UE 120. As a result, the UE 120 may access edge computing resources on EDNs associated with partners of the primary ECS 311a. This may reduce latency for more applications executed by the UE 120 than if the UE 120 were only to access edge computing resources on EDNs associated with the primary ECS 311a.

As shown in FIG. 4B, in example 410, a UE 120 is connected to a wireless network 100b, where wireless network 100b is a roaming network for the UE 120 (e.g., a visited PLMN or vPLMN) as distinct from the wireless network 100a that is an hPLMN for the UE 120. Accordingly, as shown in FIG. 4B, the UE 120 may contact a primary ECS 311a-1 within the hPLMN 100a and/or a primary ECS 311a-2 within the vPLMN 100b. As a result, the UE 120 may access edge computing resources on EDNs associated with both the hPLMN and the vPLMN. This may reduce latency for more applications executed by the UE 120 than if the UE 120 were only to access edge computing resources on EDNs associated with the primary ECS 311a-1.

In example 410, a UE 120 is connected to a wireless network 100b, where wireless network 100b is a roaming network for the UE 120 (e.g., a visited PLMN or vPLMN) as distinct from the wireless network 100a that is an hPLMN for the UE 120. Accordingly, as shown in FIG. 4B, the UE 120 may contact a primary ECS 311a-1 within the hPLMN 100a and/or a primary ECS 311a-2 within the vPLMN 100b. As a result, the UE 120 may access edge computing resources on EDNs associated with both the hPLMN and the vPLMN. This may reduce latency for more applications executed by the UE 120 than if the UE 120 were only to access edge computing resources on EDNs associated with the primary ECS 311a-1.

As shown in FIG. 4C, in example 420a, a UE 120 is connected to a wireless network 100b, where wireless network 100b is a vPLMN for the UE 120, as distinct from the wireless network 100a that is an hPLMN for the UE 120. Accordingly, as shown in FIG. 4C, the UE 120 may contact a primary ECS 311a within the vPLMN 100b. As further shown in FIG. 4C, the primary ECS 311a is configured to receive information associated with partner ECSs (e.g., partner ECS 311b at least partially within the hPLMN, partner ECS 311d shared by the hPLMN and the vPLMN, partner ECS 311e within the vPLMN, partner ECS 311f at least partially within the vPLMN, and/or another partner ECS within the hPLMN) and provide the information to an EEC of the UE 120. As a result, the UE 120 may access edge computing resources on EDNs associated with partners of the primary ECS 311a and/or associated with the hPLMN. This may reduce latency for more applications executed by the UE 120 than if the UE 120 were only to access edge computing resources on EDNs associated with the primary ECS 311a and within the vPLMN.

In example 420b, a UE 120 is connected to a wireless network 100a, where wireless network 100b is a vPLMN for the UE 120, as distinct from the wireless network 100a that is an hPLMN for the UE 120. Accordingly, as shown in FIG. 4C, the UE 120 may contact a primary ECS 311a within the hPLMN 100a. As further shown in FIG. 4C, the primary ECS 311a is configured to receive information associated with partner ECSs (e.g., partner ECS 311b at least partially within the hPLMN, partner ECS 311d shared by the hPLMN and the vPLMN, partner ECS 311e within the hPLMN, partner ECS 311f at least partially within the vPLMN, and/or another partner ECS within the vPLMN) and provide the information to an EEC of the UE 120. As a result, the UE 120 may access edge computing resources on EDNs associated with partners of the primary ECS 311a and/or associated with the vPLMN. This may reduce latency for more applications executed by the UE 120 than if the UE 120 were only to access edge computing resources on EDNs associated with the primary ECS 311a and within the hPLMN.

Some techniques and apparatuses described herein enable an edge repository (e.g., associated with an operator, such as an operator of a wireless network like an hPLMN or a vPLMN) to store information associated with ECSs associated with the operator and ECSs associated with other operators. As a result, ECSs may access information stored in the edge repository in order to provide information on EDNs provided by partner ECSs, both associated with the operator and associated with other operators. Accordingly, an EEC (e.g., executed by a UE 120) may access edge computing resources for more applications executed by the UE 120, which reduces latency.

As indicated above, FIG. 4A-4C are provided as examples. Other examples may differ from what is described with respect to FIGS. 4A-4C.

FIG. 5 is a diagram illustrating an example 500 associated with an edge repository in edge computing architecture, in accordance with the present disclosure. Example 500 is similar to example 300 but further includes an edge repository 401a associated with a mobile network operation (MNO) of the wireless network 100 and an edge repository 401b associated with an additional MNO.

The edge repository 401a may be used to discover ECSs within the MNO and across MNOs (e.g., with the additional edge repository). In some aspects, the edge repository 401a may store information associated with ECSs 311a and 311b programmed (and/or otherwise preconfigured) by the MNO. Similarly, the edge repository 401a may store information associated with ECSs operated by the additional MNO programmed (and/or otherwise preconfigured) based on a service-level agreement (SLA) between the MNO and the additional MNO.

The edge repositories 401a and 401b may be implemented at an application layer. Alternatively, the edge repositories 401a and 401b may be implemented as network functions within core networks operated by the MNO and the additional MNO, respectively. In some aspects, the edge repository 401a may be implemented at least partially within (e.g., physically, logically, and/or virtually) the ECS 311a or the ECS 311b. In such implementations, the edge repository 401a may be referred to as a “designated ECS” or an “ECS-edge repository,” among other examples. Alternatively, the edge repository 401a may be a federated repository jointly operated by the MNO and one or more partner MNOs. Alternatively, the edge repository 401a may be operated by an edge computing service provider (ECSP), or jointly operated by multiple ECSPs.

As further shown in FIG. 10, the edge repository 401a may communicate with the ECS 311a and the ECS 311b on an EDGE-11 interface. For example, the edge repository 401a may receive (and store) information associated with edge computing resources associated with the ECS 311a and the ECS 311b. In implementations where the edge repository 401a is implemented at least partially within the ECS 311a or the ECS 311b (e.g., physically, logically, and/or virtually), the EDGE-11 interface may be implemented as part of the EDGE-10 interface.

In some aspects, the ECS 311a and the ECS 311b may each register with the edge repository 401a and transmit, to the edge repository 401a, ECS configuration information (e.g., an ECS address and/or ECS provider information), applications available via the ECS (e.g., a list of edge application servers available through the ECS), EDN configuration information (e.g., a data network name (DNN) and/or single network slice selection assistance information (S-NSSAI)), a list of partner MNOs, and/or a list of partner ECSs. For example, the information associated with the edge computing resources associated with the ECS 311a and the ECS 311b may be included in registration requests. In some aspects, the edge repository 401a may verify credentials of the ECS 311a and the ECS 311b before storing the information included in the registration requests. Additionally, the edge repository 401a may transmit a registration response indicating success or failure of storing the information. In some aspects, the registration request may be referred to as a “publish request” or another similar term, and the registration response may be referred to as a “publish response” or another similar term.

Similarly, the ECS 311a and the ECS 311b may de-register with the edge repository 401a. For example, the ECS 311a and the ECS 311b may transmit de-registration requests. In some aspects, the edge repository 401a may verify credentials of the ECS 311a and the ECS 311b before removing the information associated with the ECS 311a and the ECS 311b, respectively. Additionally, the edge repository 401a may transmit a de-registration response indicating success or failure of removing the information. In some aspects, the edge repository 401a may remove the information associated with the ECS 311a and the ECS 311b based on the ECS 311a and the ECS 311b, respectively, not transmitting a registration update request before an expiry time associated with the registration requests. The expiry time may be indicated in the registration responses. As described above, the registration update request may be referred to as a “publish update request” or another similar term, and the registration update response may be referred to as a “publish update response” or another similar term.

The ECS 311a and the ECS 311b may further update the information stored at the edge repository 401a. For example, the ECS 311a and the ECS 311b may transmit registration update requests. In some aspects, the edge repository 401a may verify credentials of the ECS 311a and the ECS 311b before updating the information associated with the ECS 311a and the ECS 311b, respectively. Additionally, the edge repository 401a may transmit a registration update response indicating success or failure of updating the information. In some aspects, the ECS 311a and the ECS 311b may transmit registration update requests before an expiry time in order to prevent the edge repository 401a from removing the information. Accordingly, the edge repository 401a may renew the information rather than updating the information.

As further shown in FIG. 5, the edge repository 401a may communicate with the edge repository 401b on an EDGE-12 interface. For example, the edge repository 401a may transmit information associated with the ECS 311a and/or the ECS 311b to the edge repository 401b, and/or the edge repository 401b may transmit information associated with one or more ECSs associated with the additional MNO. In implementations where the edge repository 401a is implemented at least partially within the ECS 311a or the ECS 311b (e.g., physically, logically, and/or virtually), the EDGE-12 interface may be implemented as part of the EDGE-10 interface.

In some aspects, the edge repository 401a may transmit a discovery request to the edge repository 401b. In response, the edge repository 401b may transmit a list of ECSs (as well as ECS provider information and/or ECS endpoints) associated with the additional MNO. In some aspects, the discovery request may include one or more query parameters, such as an identifier of a requesting ECS (e.g., ECS 311a or ECS 311b), an indication of a preferred ECS provider, and/or one or more application identifiers (e.g., an edge application server identifier (EASID) and/or an application context identifier (ACID)). Accordingly, the edge repository 401b may transmit a response satisfying the one or more query parameters.

The edge repository 401a may similarly respond to discovery requests from the edge repository 401b. In some aspects, the ECS 311a (and/or the ECS 311b) may provide a set of partner ECSs and/or a set of partner operators (e.g., in a registration request and/or a registration update request) such that the edge repository 401a only indicates the ECS 311a (and/or the ECS 311b) to the edge repository 401b when an ECS associated with the discovery request is included in the set of partner ECSs and/or the additional MNO is included in the set of partner operators, respectively.

Similarly, the ECS 311a (or the ECS 311b) may transmit a discovery request to the edge repository 401a. In response, the edge repository 401a may transmit a list of ECSs (as well as ECS provider information and/or ECS endpoints). In some aspects, the discovery request may include one or more query parameters, such as an identifier of a requesting ECS (e.g., ECS 311a or ECS 311b), an indication of a preferred ECS provider, and/or one or more application identifiers (e.g., an EASID and/or an ACID). Accordingly, the edge repository 401a may transmit a response satisfying the one or more query parameters.

In some aspects, discovery requests transmitted by the edge repository 401a or the ECS 311a may be implemented as query requests. Similarly, discovery responses may be implemented as query responses. In some aspects, the discovery request may include indications to create a subscription related to one or more query parameters, in which case the discovery responses may be implemented as notifications. Subsequent notifications may follow related to the subscription created by the received discovery request.

In some aspects, the ECS 311a (and/or the ECS 311b) may provide a set of partner ECSs and/or a set of partner operators (e.g., in a registration request and/or a registration update request) such that the edge repository 401a, in response to the discovery request from ECS 311a (or the ECS 311b), only indicates the ECS 311a (and/or the ECS 311b) to a querying ECS (e.g., ECS 311a, ECS 311b, and/or another ECS) when the querying ECS is included in the set of partner ECSs.

By using the edge repositories 401a and 401b, the ECSs 311a and 311b may provide information on EDNs provided by partner ECSs, both associated with the MNO and associated with other MNOs. Accordingly, the EEC 309 may access edge computing resources for more applications executed by the UE 120, which reduces latency.

As indicated above, FIG. 5 is provided as an example. Other examples may differ from what is described with respect to FIG. 5.

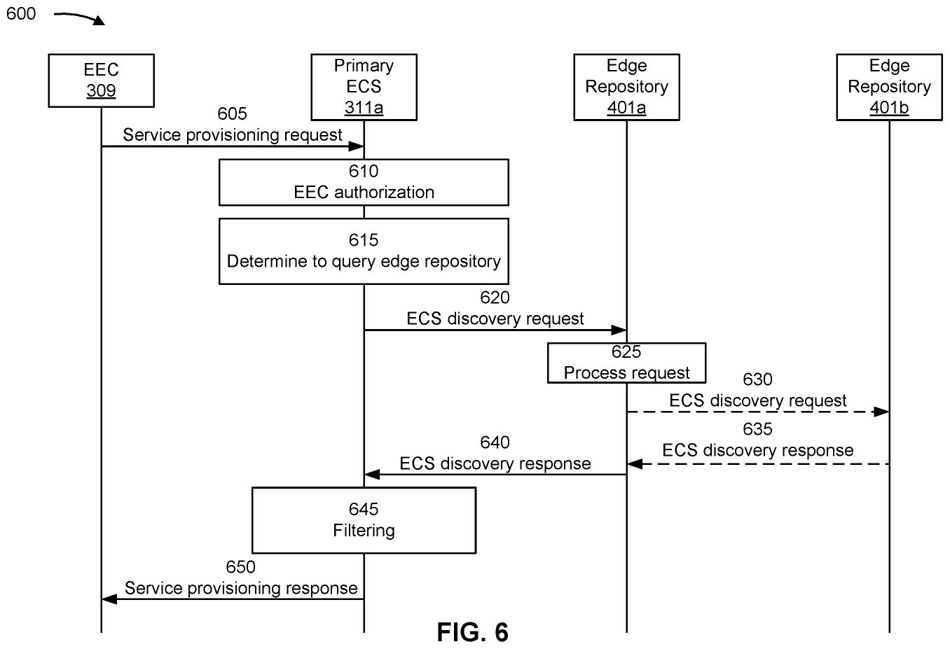

FIG. 6 is a diagram illustrating an example 600 associated with using an edge repository, in accordance with the present disclosure. As shown in FIG. 6, an EEC 309 (e.g., executed on a UE 120) may communicate with a primary ECS 311a (e.g., via a wireless network, such as wireless network 100 of FIG. 1). Additionally, the primary ECS 311a may communicate with an edge repository 401a (e.g., on an EDGE-11 interface). Additionally, in some aspects, the edge repository 401a may communicate with an edge repository 401b (e.g., on an EDGE-12 interface).

As shown by reference number 605, the EEC 309 may transmit, and the primary ECS 311a may receive, a service provisioning request. In some aspects, the service provisioning request may include credentials associated with the EEC 309 (e.g., received by the EEC 309 during an EEC authorization procedure with the primary ECS 311a). Additionally, or alternatively, the service provisioning request may include an identifier associated with the UE 120 (e.g., a generic public subscription identifier (GPSI)), connectivity information, a location associated with the UE 120, and/or a profile associated with an application client associated with the EEC 309. In some aspects, the service provisioning request may include an identifier (ID) of the PLMN on which the UE 120 is camped (e.g., a vPLMN ID).

As shown by reference number 610, the primary ECS 311a may authorize the EEC 309. For example, the primary ECS 311a may use the credentials. Additionally, or alternatively, the primary ECS 311a may use a location associated with the UE 120 and/or additional information included in the service provisioning request to authorize the EEC 309 via the wireless network 100. Additionally, the primary ECS 311a may enforce any policy associated with the UE 120 and service differentiation.

As shown by reference number 615, the primary ECS 311a may determine to query the edge repository 401a based on the service provisioning request. For example, the primary ECS 311a may determine that at least one application indicated by the service provisioning request is not available via the primary ECS 311a.

Accordingly, as shown by reference number 620, the primary ECS 311a may transmit, and the edge repository 401a may receive, a discovery request. The discovery request may include information as described in connection with FIG. 5 and/or information included in the service provisioning request.

As shown by reference number 625, the edge repository 401a processes the discovery request. For example, as described in connection with FIG. 5, the edge repository 401a may generate a discovery response (e.g., based on one or more query parameters indicated in the discovery request). In some aspects, discovery requests transmitted by the ECS 311a may be implemented as query requests. Similarly, the discovery responses generated by the edge repository 401a may be implemented as query responses. In some aspects, the discovery request may include indications to create a subscription related to one or more query parameters, in which case the discovery responses may be implemented as notifications. Subsequent notifications may follow related to the subscription created by the received discovery request.

In some aspects, and as shown by reference number 630, the edge repository 401a may transmit, and the edge repository 401b may receive, a discovery request based on the discovery request from the primary ECS 311a. For example, the edge repository 401a may transmit the discovery request to the edge repository 401b when the discovery request from the primary ECS 311a indicates a different PLMN than the hPLMN associated with the UE 120. Accordingly, the edge repository 401b may be associated with the vPLMN indicated in the discovery request from the primary ECS 311a (which, in turn, was indicated in the service provisioning request from the EEC 309).

Accordingly, as shown by reference number 635, the edge repository 401b may transmit, and the edge repository 401a may receive, a discovery response. The discovery response may include information as described in connection with FIG. 5. some aspects, the discovery requests transmitted by the edge repository 401a may be implemented as query requests. Similarly, the discovery responses transmitted by the edge repository 401b may be implemented as query responses. In some aspects, the discovery request may include indications to create a subscription related to one or more query parameters, in which case the discovery responses may be implemented as notifications. Subsequent notifications may follow related to the subscription created by the received discovery request.

As shown by reference number 640, the edge repository 401a may transmit, and the primary ECS 311a may receive, a discovery response. The discovery response may include information as described in connection with FIG. 5. In some aspects, the discovery response may indicate edge computing resources provided by one or more EDNs associated with the primary ECS 311a, edge computing resources provided by one or more EDNs associated with a partner ECS (and indicated by the edge repository 401a), and/or edge computing resources provided by one or more EDNs associated with a partner ECS and associated with a partner operator (and indicated by the edge repository 401b to the edge repository 401a).

In some aspects, and as shown by reference number 645, the primary ECS 311a may apply filtering. For example, the primary ECS 311a may filter results included in the discovery response based on one or more local policies and/or any policy associated with the UE 120 and service differentiation.

Accordingly, as shown by reference number 650, the primary ECS 311a may transmit, and the EEC 309 may receive, a service provisioning response. The service provisioning response may include an indication of ECSs that can provide the edge computing resources indicated by the service provisioning request.

By using techniques as described in connection with FIG. 6, the EEC 309 may access edge computing resources provided by partner ECSs of the primary ECS 311a. As a result, more applications executed by the UE 120 experience reduced latency by accessing the edge computing resources.

As indicated above, FIG. 6 is provided as an example. Other examples may differ from what is described with respect to FIG. 6.

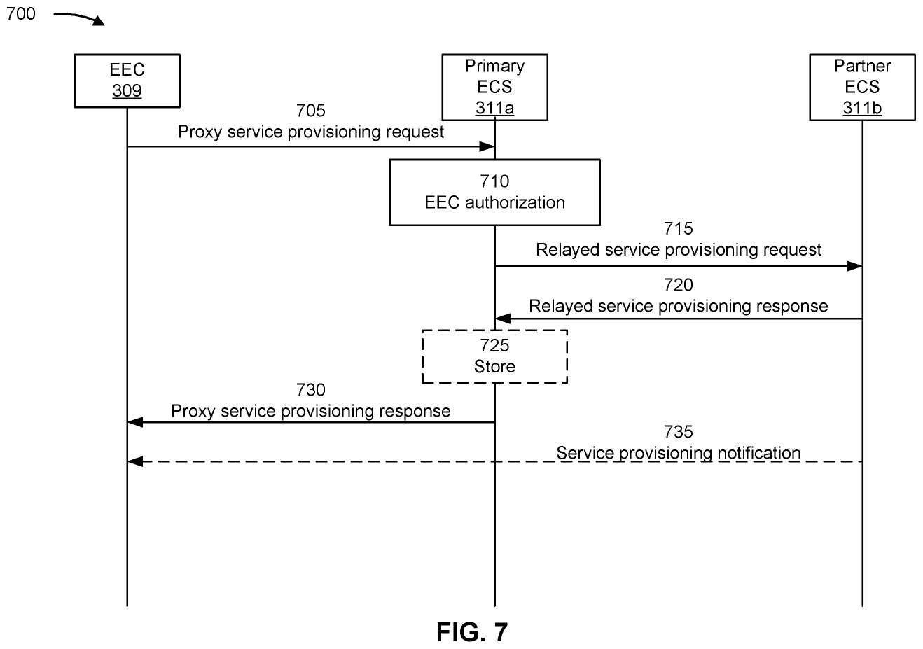

FIG. 7 is a diagram illustrating an example 700 associated with using an edge repository, in accordance with the present disclosure. As shown in FIG. 7, an EEC 309 (e.g., executed on a UE 120) may communicate with a primary ECS 311a (e.g., via a wireless network, such as wireless network 100 of FIG. 1). Additionally, the primary ECS 311a may communicate with a partner ECS 311b (e.g., on an EDGE-10 interface). The partner ECS 311b may be associated with a same operator as the primary ECS 311a or with a different operator.

As shown by reference number 705, the EEC 309 may transmit, and the primary ECS 311a may receive, a proxy service provisioning request. For example, the EEC 309 may transmit the proxy service provisioning request based on selecting the partner ECS 311b from a list of ECSs provided by the primary ECS 311a (e.g., as described in connection with FIG. 6). The proxy service provisioning request may include information as described for service provisioning requests in connection with FIG. 6. Additionally, in some aspects, the proxy service provisioning request may include a notification destination address (e.g., associated with the UE 120) in order to subscribe to service provisioning information from the partner ECS 311b.

As shown by reference number 710, the primary ECS 311a may authorize the EEC 309. For example, the primary ECS 311a may use credentials included in the proxy service provisioning request. Additionally, or alternatively, the primary ECS 311a may use a location associated with the UE 120 and/or additional information included in the proxy service provisioning request to authorize the EEC 309 via the wireless network 100. Additionally, the primary ECS 311a may enforce any policy associated with the UE 120 and service differentiation.

As shown by reference number 715, the primary ECS 311a may transmit, and the partner ECS 311b may receive, a relayed service provisioning request. The relayed service provisioning request may include information from the proxy service provisioning request.

Accordingly, as shown by reference number 720, the partner ECS 311b may transmit, and the primary ECS 311a may receive, a relayed service provisioning response. In some aspects, the relayed service provisioning response may include EDN configuration information, associated with the partner ECS 311b and with the one or more applications indicated by the proxy service provisioning request, along with a token (or other credential) authorizing the EEC 309 to communicate with one or more edge enabler servers of the EDN. Additionally, or alternatively, the relayed service provisioning response may include a subscription identifier and a token (or other credential) such that the EEC 309 may verify subscription notifications from the partner ECS 311b.

In some aspects, and as shown by reference number 725, the primary ECS 311a may store information from the relayed service provisioning response (e.g., the EDN configuration information). For example, the primary ECS 311a may provide the EDN configuration information in response to future service provisioning requests from the EEC 309 and/or a different EEC.

As shown by reference number 730, the primary ECS 311a may transmit, and the EEC 309 may receive, a proxy service provisioning response. The proxy service provisioning response may include information from the relayed service provisioning response.

In some aspects, the EEC 309 may subscribe to service provisioning information from the partner ECS 311b. Accordingly, as shown by reference number 735, the partner ECS 311b may transmit, and the EEC 309 may receive, a service provisioning notification including the token (or other credential) such that the EEC 309 may verify the notification from the partner ECS 311b. Additionally, the service provisioning notification may include EDN configuration information, associated with the partner ECS 311b and with the one or more applications indicated by the proxy service provisioning request, along with a token (or other credential) authorizing the EEC 309 to communicate with one or more edge enabler servers of the EDN.

By using techniques as described in connection with FIG. 7, the EEC 309 may access edge computing resources provided by the partner ECS 311b. As a result, more applications executed by the UE 120 experience reduced latency by accessing the edge computing resources.

As indicated above, FIG. 7 is provided as an example. Other examples may differ from what is described with respect to FIG. 7.

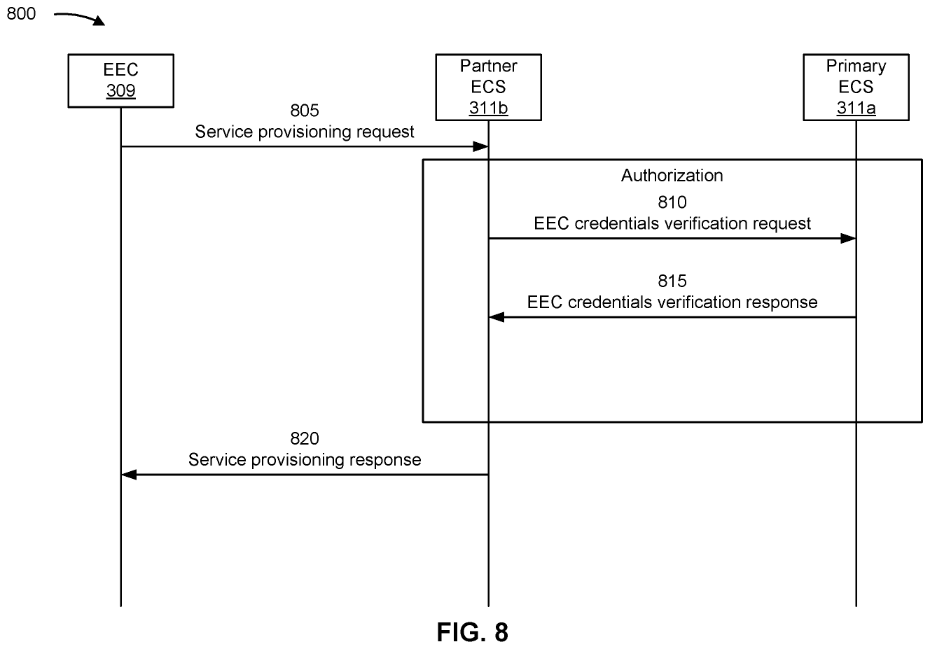

FIG. 8 is a diagram illustrating an example 800 associated with using an edge repository, in accordance with the present disclosure. As shown in FIG. 8, an EEC 309 (e.g., executed on a UE 120) may communicate with a partner ECS 311b (e.g., via a wireless network, such as wireless network 100 of FIG. 1). Additionally, the partner ECS 311b may communicate with a primary ECS 311a (e.g., on an EDGE-10 interface). The partner ECS 311b may be associated with a same operator as the primary ECS 311a or with a different operator. Example 800 allows for the EEC 309 to access edge computing resources provided by one or more EDNs associated with the partner ECS 311b, similar to example 700.

As shown by reference number 805, the EEC 309 may transmit, and the partner ECS 311b may receive, a service provisioning request. For example, the EEC 309 may transmit the service provisioning request based on selecting the partner ECS 311b from a list of ECSs provided by the primary ECS 311a (e.g., as described in connection with FIG. 6). The service provisioning request may include information as described for service provisioning requests in connection with FIG. 6.

Accordingly, as shown by reference number 810, the partner ECS 311b may transmit a request for the primary ECS 311a to verify credentials of the EEC 309. For example, the partner ECS 311b may include credentials from the service provisioning request with the request to the primary ECS 311a.

As shown by reference number 815, the primary ECS 311a may transmit a response verifying the credentials of the EEC 309. Therefore, as shown by reference number 820, the partner ECS 311b may transmit, and the EEC 309 may receive, a service provisioning response. For example, the partner ECS 311b may transmit the service provisioning response based on the primary ECS 311a verifying the credentials of the EEC 309. In some aspects, the service provisioning response may include EDN configuration information, associated with the partner ECS 311b and with the one or more applications indicated by the service provisioning request, along with a token (or other credential) authorizing the EEC 309 to communicate with one or more edge enabler servers of the EDN.

By using techniques as described in connection with FIG. 8, the EEC 309 may access edge computing resources provided by the partner ECS 311b. As a result, more applications executed by the UE 120 experience reduced latency by accessing the edge computing resources.

As indicated above, FIG. 8 is provided as an example. Other examples may differ from what is described with respect to FIG. 8.

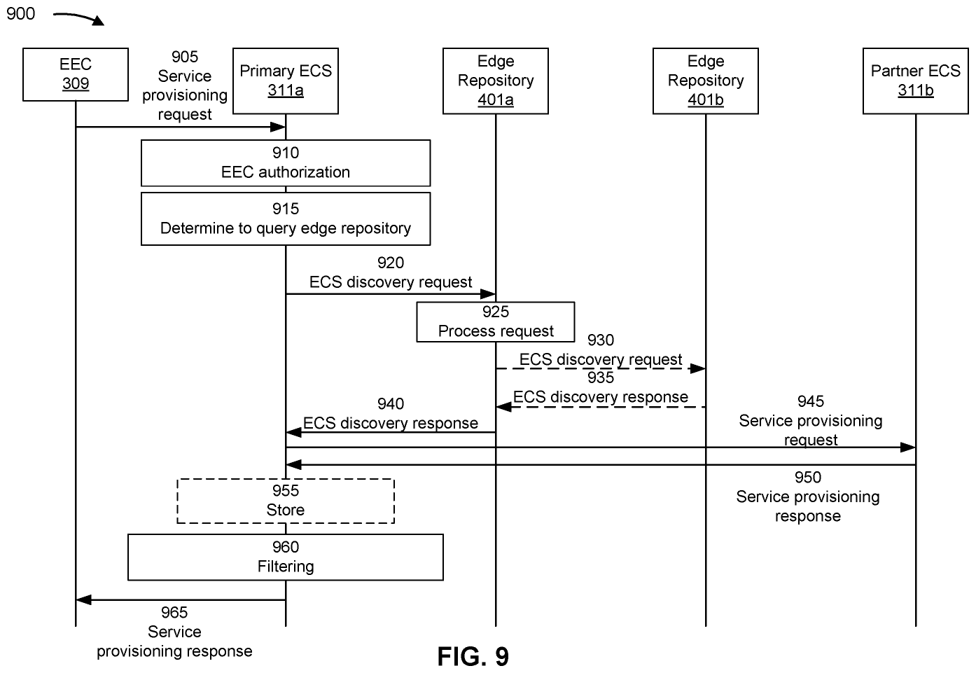

FIG. 9 is a diagram illustrating an example 900 associated with using an edge repository, in accordance with the present disclosure. As shown in FIG. 9, an EEC 309 (e.g., executed on a UE 120) may communicate with a primary ECS 311a (e.g., via a wireless network, such as wireless network 100 of FIG. 1). Additionally, the primary ECS 311a may communicate with an edge repository 401a (e.g., on an EDGE-11 interface), and the edge repository 401a may communicate with an edge repository 401b (e.g., on an EDGE-12 interface). Additionally, the primary ECS 311a may communicate with a partner ECS 311b (e.g., on an EDGE-10 interface). The partner ECS 311b may be associated with a same operator as the primary ECS 311a or with a different operator.

Example 900 shows a combination of example 600 with example 700. Accordingly, processes shown in reference numbers 905, 910, 915, 920, 925, 930, 935, 940, and 960 may be similar to processes described in connection with reference numbers 605, 610, 615, 620, 625, 630, 635, 640, and 645 of FIG. 6, respectively. Additionally, processes shown by reference number 945, 950, 955, and 965 may be similar to processes described in connection with 715, 720, 730, and 735 of FIG. 7, respectively. As a result, the EEC 309 may access edge computing resources by transmitting a single service provisioning request.

By using techniques as described in connection with FIG. 9, the EEC 309 may access edge computing resources provided by the partner ECS 311b. As a result, more applications executed by the UE 120 experience reduced latency by accessing the edge computing resources.

As indicated above, FIG. 9 is provided as an example. Other examples may differ from what is described with respect to FIG. 9.

FIG. 10 is a diagram illustrating an example process 1000 performed, for example, by an edge repository, in accordance with the present disclosure. Example process 1000 is an example where the edge repository (e.g., edge repository 401a and/or apparatus 1400 of FIG. 14) performs operations associated with using the edge repository.

As shown in FIG. 10, in some aspects, process 1000 may include receiving, from at least one first ECS (e.g., ECS 311 and/or apparatus 1500 of FIG. 15) associated with an operator of the edge repository, first information associated with edge computing resources associated with the at least one first ECS (block 1010). For example, the edge repository (e.g., using communication manager 150 and/or reception component 1402, depicted in FIG. 14) may receive, from at least one first ECS associated with an operator of the edge repository, first information associated with edge computing resources associated with the at least one first ECS, as described herein.

As further shown in FIG. 10, in some aspects, process 1000 may include receiving, from at least one additional edge repository, associated with at least one additional operator, second information associated with edge computing resources associated with at least one second ECS (block 1020). For example, the edge repository (e.g., using communication manager 150 and/or reception component 1402) may receive, from at least one additional edge repository, associated with at least one additional operator, second information associated with edge computing resources associated with at least one second ECS, as described herein.

As further shown in FIG. 10, in some aspects, process 1000 may include transmitting, to the at least one first ECS, the first information, the second information, or a combination thereof (block 1030). For example, the edge repository (e.g., using communication manager 150 and/or transmission component 1404, depicted in FIG. 14) may transmit, to the at least one first ECS, the first information, the second information, or a combination thereof, as described herein.

Process 1000 may include additional aspects, such as any single aspect or any combination of aspects described below and/or in connection with one or more other processes described elsewhere herein.

In a first aspect, process 1000 further includes transmitting (e.g., using communication manager 150 and/or transmission component 1404), to the at least one additional edge repository, associated with the at least one additional operator, the first information.

In a second aspect, alone or in combination with the first aspect, the first information is associated with a set of partner ECSs, and the first information is transmitted to the at least one first additional edge repository based on the at least one first ECS being included in the set of partner ECSs.

In a third aspect, alone or in combination with one or more of the first and second aspects, the first information is associated with a set of partner operators, and the first information is transmitted to the at least one additional edge repository based on the at least one additional edge repository being associated with at least one operator included in the set of partner operators.

In a fourth aspect, alone or in combination with one or more of the first through third aspects, transmitting the first information includes receiving (e.g., using communication manager 150 and/or reception component 1402) a discovery request, from the at least one additional edge repository, associated with the at least one additional operator, and transmitting (e.g., using communication manager 150 and/or transmission component 1404) the first information.

In a fifth aspect, alone or in combination with one or more of the first through fourth aspects, receiving the first information includes receiving (e.g., using communication manager 150 and/or reception component 1402) a registration request, from the at least one first ECS, that includes the first information, and storing (e.g., using communication manager 150 and/or storage component 1408, depicted in FIG. 14) the first information.

In a sixth aspect, alone or in combination with one or more of the first through fifth aspects, process 1000 further includes receiving (e.g., using communication manager 150 and/or reception component 1402) a registration update request, from the at least one first ECS, and updating (e.g., using communication manager 150 and/or storage component 1408) the first information based on the registration update request.

In a seventh aspect, alone or in combination with one or more of the first through sixth aspects, process 1000 further includes receiving (e.g., using communication manager 150 and/or reception component 1402) a de-registration request, from the at least one first ECS, and removing (e.g., using communication manager 150 and/or storage component 1408) the first information.

In an eighth aspect, alone or in combination with one or more of the first through seventh aspects, process 1000 further includes removing (e.g., using communication manager 150 and/or storage component 1408) the first information based on not receiving a registration update request before an expiry time associated with the registration request.

In a ninth aspect, alone or in combination with one or more of the first through eighth aspects, receiving the second information includes transmitting (e.g., using communication manager 150 and/or transmission component 1404), to the at least one additional edge repository, associated with the at least one additional operator, a discovery request associated with the second information; receiving (e.g., using communication manager 150 and/or reception component 1402) the second information from the at least one additional edge repository, associated with the at least one additional operator; and storing (e.g., using communication manager 150 and/or storage component 1408) the second information.

In a tenth aspect, alone or in combination with one or more of the first through ninth aspects, transmitting the first information, the second information or a combination thereof includes receiving (e.g., using communication manager 150 and/or reception component 1402) a discovery request, from at least one first ECS, associated with the first information, and transmitting (e.g., using communication manager 150 and/or transmission component 1404) the first information, the second information or a combination thereof.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by an ECS, in accordance with the present disclosure. Example process 1100 is an example where the ECS (e.g., ECS 311 and/or apparatus 1500 of FIG. 15) performs operations associated with using an edge repository.

As shown in FIG. 11, in some aspects, process 1100 may include transmitting, to an edge repository (e.g., edge repository 401a and/or apparatus 1400 of FIG. 14) associated with an operator, a registration request including information associated with edge computing resources associated with the ECS (block 1110). For example, the ECS (e.g., using communication manager 150 and/or transmission component 1504, depicted in FIG. 15) may transmit, to an edge repository associated with an operator, a registration request including information associated with edge computing resources associated with the ECS, as described herein.

As further shown in FIG. 11, in some aspects, process 1100 may include receiving, from the edge repository, a response to the registration request (block 1120). For example, the ECS (e.g., using communication manager 150 and/or reception component 1502, depicted in FIG. 15) may receive, from the edge repository, a response to the registration request, as described herein.

Process 1100 may include additional aspects, such as any single aspect or any combination of aspects described below and/or in connection with one or more other processes described elsewhere herein.

In a first aspect, process 1100 further includes transmitting (e.g., using communication manager 150 and/or transmission component 1504), to the edge repository, a registration update request, and receiving (e.g., using communication manager 150 and/or reception component 1502), from the edge repository, a response to the registration update request.

In a second aspect, alone or in combination with the first aspect, process 1100 further includes transmitting (e.g., using communication manager 150 and/or transmission component 1504), to the edge repository, a de-registration request, and receiving (e.g., using communication manager 150 and/or reception component 1502), from the edge repository, a response to the de-registration request.

In a third aspect, alone or in combination with one or more of the first and second aspects, the registration request is transmitted based on an address of the edge repository stored in a memory of the ECS.

In a fourth aspect, alone or in combination with one or more of the first through third aspects, the registration request includes configuration information and credentials associated with the ECS.

In a fifth aspect, alone or in combination with one or more of the first through fourth aspects, the registration request indicates a set of partner ECSs, a set of partner operators, or a combination thereof.

In a sixth aspect, alone or in combination with one or more of the first through fifth aspects, the response indicates an expiry time, and process 1100 further includes transmitting (e.g., using communication manager 150 and/or transmission component 1504), to the edge repository, a registration update request before the expiry time.

In a seventh aspect, alone or in combination with one or more of the first through sixth aspects, the ECS is a primary ECS, and process 1100 further includes receiving (e.g., using communication manager 150 and/or reception component 1502), from an EEC (e.g., EEC 309 and/or apparatus 1300 of FIG. 13), a service provisioning request, and transmitting (e.g., using communication manager 150 and/or transmission component 1504), to the EEC, information associated with edge computing resources associated with one or more applications indicated by the service provisioning request.

In an eighth aspect, alone or in combination with one or more of the first through seventh aspects, process 1100 further includes transmitting (e.g., using communication manager 150 and/or transmission component 1504), to the edge repository, a discovery request based on the service provisioning request, and receiving (e.g., using communication manager 150 and/or reception component 1502), from the edge repository, a discovery response associated with one or more partner ECSs, wherein the information associated with the edge computing resources, associated with the one or more applications, indicates the one or more partner ECSs.

In a ninth aspect, alone or in combination with one or more of the first through eighth aspects, the ECS is a primary ECS, and process 1100 further includes receiving (e.g., using communication manager 150 and/or reception component 1502), from an EEC, a proxy service provisioning request, and transmitting (e.g., using communication manager 150 and/or transmission component 1504), to the EEC, information associated with an EDN providing edge computing resources associated with one or more applications indicated by the service provisioning request.

In a tenth aspect, alone or in combination with one or more of the first through ninth aspects, the proxy service provisioning request includes credentials associated with the EEC.

In an eleventh aspect, alone or in combination with one or more of the first through tenth aspects, process 1100 further includes authorizing (e.g., using communication manager 150 and/or authorization component 1508, depicted in FIG. 15) the EEC based on the credentials, such that the information associated with the EDN is transmitted based on authorizing the EEC.

In a twelfth aspect, alone or in combination with one or more of the first through eleventh aspects, process 1100 further includes transmitting (e.g., using communication manager 150 and/or transmission component 1504), to a partner ECS, a relayed service provisioning request based on the proxy service provisioning request, and receiving (e.g., using communication manager 150 and/or reception component 1502), from the partner ECS, a relayed service provisioning response associated with the EDN providing the edge computing resources associated with the one or more applications.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by an EEC, in accordance with the present disclosure. Example process 1200 is an example where the EEC (e.g., EEC 309 and/or apparatus 1300 of FIG. 13) performs operations associated with using an edge repository.

As shown in FIG. 12, in some aspects, process 1200 may include transmitting, to a primary ECS (e.g., ECS 311 and/or apparatus 1500 of FIG. 15), a service provisioning request (block 1210). For example, the EEC (e.g., using communication manager 140 and/or transmission component 1304, depicted in FIG. 13) may transmit, to a primary ECS, a service provisioning request, as described herein.

As further shown in FIG. 12, in some aspects, process 1200 may include receiving, from the primary ECS, information associated with one or more partner ECSs associated with one or more applications indicated by the service provisioning request (block 1220). For example, the EEC (e.g., using communication manager 140 and/or reception component 1302, depicted in FIG. 13) may receive, from the primary ECS, information associated with one or more partner ECSs associated with one or more applications indicated by the service provisioning request, as described herein.

Process 1200 may include additional aspects, such as any single aspect or any combination of aspects described below and/or in connection with one or more other processes described elsewhere herein.

In a first aspect, the service provisioning request includes credentials associated with the EEC.

In a second aspect, alone or in combination with the first aspect, process 1200 further includes transmitting (e.g., using communication manager 140 and/or transmission component 1304), to the primary ECS, a proxy service provisioning request, and receiving (e.g., using communication manager 140 and/or reception component 1302), from the primary ECS, information associated with an EDN providing edge computing resources associated with one or more applications indicated by the service provisioning request.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be an EEC, or an EEC may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include an application component 1308, among other examples.

In some aspects, the apparatus 1300 may be configured to perform one or more operations described herein in connection with FIGS. 5-9. Additionally, or alternatively, the apparatus 1300 may be configured to perform one or more processes described herein, such as process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the transmission component 1304 may transmit, to a primary ECS, a service provisioning request. For example, the application component 1308 may execute one or more applications that are requesting edge computing resources. Accordingly, the reception component 1302 may receive, from the primary ECS, information associated with one or more partner ECSs associated with one or more applications indicated by the service provisioning request.

In some aspects, the transmission component 1304 may transmit, to the primary ECS, a proxy service provisioning request. Accordingly, the reception component 1302 may receive, from the primary ECS, information associated with an EDN providing edge computing resources associated with one or more applications indicated by the service provisioning request.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless

communication. The apparatus 1400 may be an edge repository, or an edge repository may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a storage component 1408, among other examples.

In some aspects, the apparatus 1400 may be configured to perform one or more operations described herein in connection with FIGS. 5-9. Additionally, or alternatively, the apparatus 1400 may be configured to perform one or more processes described herein, such as process 1000 of FIG. 10, or a combination thereof. In some aspects, the apparatus 1400 and/or one or more components shown in FIG. 14 may include one or more components of the network controller described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include a controller/processor, a memory, a communication unit, or a combination thereof, of the network controller described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include a controller/processor, a memory, a communication unit, or a combination thereof, of the network controller described in connection with FIG. 2. In some aspects, the transmission component 1404 may be co-located with the reception component 1402 in a transceiver.

In some aspects, the reception component 1402 may receive, from at least one first ECS associated with an operator of the edge repository, first information associated with edge computing resources associated with the at least one first ECS. Additionally, the reception component 1402 may receive, from at least one additional edge repository, associated with at least one additional operator, second information associated with edge computing resources associated with at least one second ECS. Accordingly, the transmission component 1404 may transmit, to the at least one first ECS, the first information, the second information, or a combination thereof.

In some aspects, the transmission component 1404 may additionally transmit, to the at least one additional edge repository, associated with the at least one additional operator, the first information.

In some aspects, the reception component 1402 may receive a registration update request, from the at least one first ECS. Accordingly, the storage component 1408 may update the first information based on the registration update request.

In some aspects, the reception component 1402 may receive a de-registration request, from the at least one first ECS. Accordingly, the storage component 1408 may remove the first information.

In some aspects, the storage component 1408 may remove the first information based on not receiving a registration update request before an expiry time associated with the registration request.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be an ECS, or an ECS may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include an authorization component 1508, among other examples.

In some aspects, the apparatus 1500 may be configured to perform one or more operations described herein in connection with FIGS. 5-9. Additionally, or alternatively, the apparatus 1500 may be configured to perform one or more processes described herein, such as process 1100 of FIG. 11, or a combination thereof. In some aspects, the apparatus 1500 and/or one or more components shown in FIG. 15 may include one or more components of the network controller described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include a controller/processor, a memory, a communication unit, or a combination thereof, of the network controller described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include a controller/processor, a memory, a communication unit, or a combination thereof, of the network controller described in connection with FIG. 2. In some aspects, the transmission component 1504 may be co-located with the reception component 1502 in a transceiver.

In some aspects, the transmission component 1504 may transmit, to an edge repository associated with an operator, a registration request including information associated with edge computing resources associated with the ECS. Accordingly, the reception component 1502 may receive, from the edge repository, a response to the registration request.

In some aspects, the transmission component 1504 may transmit, to the edge repository, a registration update request. Accordingly, the reception component 1502 may receive, from the edge repository, a response to the registration update request.

In some aspects, the transmission component 1504 may transmit, to the edge repository, a de-registration request. Accordingly, the reception component 1502 may receive, from the edge repository, a response to the de-registration request.

In some aspects, the transmission component 1504 may transmit, to the edge repository, a discovery request based on a service provisioning request. Accordingly, the reception component 1502 may receive, from the edge repository, a discovery response associated with one or more partner ECSs, where the information associated with the edge computing resources, associated with the one or more applications, indicates the one or more partner ECSs.

In some aspects, the authorization component 1508 may authorize an EEC based on credentials, such that the transmission component 1504 transmits information associated with an EDN based on the authorization component 1508 authorizing the EEC.

In some aspects, the transmission component 1504 may transmit, to a partner ECS, a relayed service provisioning request based on a proxy service provisioning request. Accordingly, the reception component 1502 may receive, from the partner ECS, a relayed service provisioning response associated with the EDN providing the edge computing resources associated with the one or more applications.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by an edge repository, comprising: receiving, from at least one first edge configuration server (ECS) associated with an operator of the edge repository, first information associated with edge computing resources associated with the at least one first ECS; receiving, from at least one additional edge repository, associated with at least one additional operator, second information associated with edge computing resources associated with at least one second ECS; and transmitting, to the at least one first ECS, the first information, the second information, or a combination thereof.

Aspect 2: The method of Aspect 1, further comprising: transmitting, to the at least one additional edge repository, associated with the at least one additional operator, the first information.

Aspect 3: The method of Aspect 2, wherein the first information is associated with a set of partner ECSs, and wherein the first information is transmitted to the at least one first additional edge repository based on the at least one first ECS being included in the set of partner ECSs.

Aspect 4: The method of any of Aspects 2 through 3, wherein the first information is associated with a set of partner operators, and wherein the first information is transmitted to the at least one additional edge repository based on the at least one additional edge repository being associated with at least one operator included in the set of partner operators.

Aspect 5: The method of any of Aspects 2 through 4, wherein transmitting the first information, comprises: receiving a discovery request, from the at least one additional edge repository, associated with the at least one additional operator; and transmitting the first information.

Aspect 6: The method of any of Aspects 1 through 5, wherein receiving the first information comprises: receiving a registration request, from the at least one first ECS, that includes the first information; and storing the first information.

Aspect 7: The method of Aspect 6, further comprising: receiving a registration update request, from the at least one first ECS; and updating the first information based on the registration update request.

Aspect 8: The method of any of Aspects 6 through 7, further comprising: receiving a de-registration request, from the at least one first ECS; and removing the first information.

Aspect 9: The method of Aspect 6, further comprising: removing the first information based on not receiving a registration update request before an expiry time associated with the registration request.

Aspect 10: The method of any of Aspects 1 through 9, wherein receiving the second information comprises: transmitting, to the at least one additional edge repository, associated with the at least one additional operator, a discovery request associated with the second information; receiving the second information from the at least one additional edge repository, associated with the at least one additional operator; and storing the second information.

Aspect 11: The method of any of Aspects 1 through 10, wherein transmitting the first information, the second information or a combination thereof comprises: receiving a discovery request, from at least one first ECS, associated with the first information; and transmitting the first information, the second information or a combination thereof.

Aspect 12: A method of wireless communication performed by an edge configuration server (ECS), comprising: transmitting, to an edge repository associated with an operator, a registration request including information associated with edge computing resources associated with the ECS; and receiving, from the edge repository, a response to the registration request.

Aspect 13: The method of Aspect 12, further comprising: transmitting, to the edge repository, a registration update request; and receiving, from the edge repository, a response to the registration update request.

Aspect 14: The method of any of Aspects 12 through 13, further comprising: transmitting, to the edge repository, a de-registration request; and receiving, from the edge repository, a response to the de-registration request.

Aspect 15: The method of any of Aspects 12 through 14, wherein the registration request is transmitted based on an address of the edge repository stored in a memory of the ECS.

Aspect 16: The method of any of Aspects 12 through 15, wherein the registration request includes configuration information and credentials associated with the ECS.

Aspect 17: The method of any of Aspects 12 through 16, wherein the registration request indicates a set of partner ECSs, a set of partner operators, or a combination thereof.

Aspect 18: The method of any of Aspects 12 through 17, wherein the response indicates an expiry time, and the method further comprises: transmitting, to the edge repository, a registration update request before the expiry time.

Aspect 19: The method of any of Aspects 12 through 18, wherein the ECS is a primary ECS, and wherein the method further comprises: receiving, from an edge enabler client (EEC), a service provisioning request; and transmitting, to the EEC, information associated with edge computing resources associated with one or more applications indicated by the service provisioning request.

Aspect 20: The method of Aspect 19, further comprising: transmitting, to the edge repository, a discovery request based on the service provisioning request; and receiving, from the edge repository, a discovery response associated with one or more partner ECSs, wherein the information associated with the edge computing resources, associated with the one or more applications, indicates the one or more partner ECSs.

Aspect 21: The method of any of Aspects 12 through 18, wherein the ECS is a primary ECS, and wherein the method further comprises: receiving, from an edge enabler client (EEC), a proxy service provisioning request; and transmitting, to the EEC, information associated with an edge data network (EDN) providing edge computing resources associated with one or more applications indicated by the service provisioning request.

Aspect 22: The method of Aspect 21, wherein the proxy service provisioning request includes credentials associated with the EEC.

Aspect 23: The method of Aspect 22, further comprising: authorizing the EEC based on the credentials, wherein the information associated with the EDN is transmitted based on authorizing the EEC.

Aspect 24: The method of any of Aspects 21 through 23, further comprising: transmitting, to a partner ECS, a relayed service provisioning request based on the proxy service provisioning request; and receiving, from the partner ECS, a relayed service provisioning response associated with the EDN providing the edge computing resources associated with the one or more applications.

Aspect 25: A method of wireless communication performed by an edge enabler client (EEC), comprising: transmitting, to a primary edge configuration server (ECS), a service provisioning request; and receiving, from the primary ECS, information associated with one or more partner ECSs associated with one or more applications indicated by the service provisioning request.

Aspect 26: The method of Aspect 25, wherein the service provisioning request includes credentials associated with the EEC.

Aspect 27: The method of any of Aspects 25 through 26, further comprising: transmitting, to the primary ECS, a proxy service provisioning request; and receiving, from the primary ECS, information associated with an edge data network (EDN) providing edge computing resources associated with one or more applications indicated by the service provisioning request.

Aspect 28: An apparatus for wireless communication at a device, comprising a processor; memory coupled with the processor; and instructions stored in the memory and executable by the processor to cause the apparatus to perform the method of one or more of Aspects 1-11.

Aspect 29: A device for wireless communication, comprising a memory and one or more processors coupled to the memory, the one or more processors configured to perform the method of one or more of Aspects 1-11.

Aspect 30: An apparatus for wireless communication, comprising at least one means for performing the method of one or more of Aspects 1-11.

Aspect 31: A non-transitory computer-readable medium storing code for wireless communication, the code comprising instructions executable by a processor to perform the method of one or more of Aspects 1-11.

Aspect 32: A non-transitory computer-readable medium storing a set of instructions for wireless communication, the set of instructions comprising one or more instructions that, when executed by one or more processors of a device, cause the device to perform the method of one or more of Aspects 1-11.

Aspect 33: An apparatus for wireless communication at a device, comprising a processor; memory coupled with the processor; and instructions stored in the memory and executable by the processor to cause the apparatus to perform the method of one or more of Aspects 12-24.

Aspect 34: A device for wireless communication, comprising a memory and one or more processors coupled to the memory, the one or more processors configured to perform the method of one or more of Aspects 12-24.

Aspect 35: An apparatus for wireless communication, comprising at least one means for performing the method of one or more of Aspects 12-24.

Aspect 36: A non-transitory computer-readable medium storing code for wireless communication, the code comprising instructions executable by a processor to perform the method of one or more of Aspects 12-24.

Aspect 37: A non-transitory computer-readable medium storing a set of instructions for wireless communication, the set of instructions comprising one or more instructions that, when executed by one or more processors of a device, cause the device to perform the method of one or more of Aspects 12-24.

Aspect 38: An apparatus for wireless communication at a device, comprising a processor; memory coupled with the processor; and instructions stored in the memory and executable by the processor to cause the apparatus to perform the method of one or more of Aspects 25-27.

Aspect 39: A device for wireless communication, comprising a memory and one or more processors coupled to the memory, the one or more processors configured to perform the method of one or more of Aspects 25-27.

Aspect 40: An apparatus for wireless communication, comprising at least one means for performing the method of one or more of Aspects 25-27.

Aspect 41: A non-transitory computer-readable medium storing code for wireless communication, the code comprising instructions executable by a processor to perform the method of one or more of Aspects 25-27.

Aspect 42: A non-transitory computer-readable medium storing a set of instructions for wireless communication, the set of instructions comprising one or more instructions that, when executed by one or more processors of a device, cause the device to perform the method of one or more of Aspects 25-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “primary ECS” is intended as a broad reference to an ECS whose address information is configured with an EEC. An EEC is authorized to communicate with the primary ECS directly. The term “partner ECS” is intended as a broad reference to a federation partner of a primary ECS. The EEC is not configured with address information of partner ECSs but may receive the address information from the primary ECS.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for communication at an edge repository, comprising:
a memory; and
one or more processors, coupled to the memory, configured to:
receive, from at least one first edge configuration server (ECS) associated with an operator of the edge repository, first information associated with edge computing resources associated with the at least one first ECS;
receive, from at least one additional edge repository, associated with at least one additional operator, second information associated with edge computing resources associated with at least one second ECS; and
transmit, to the at least one first ECS, the first information, the second information, or a combination thereof.

2. The apparatus of claim 1, wherein the one or more processors are further configured to:
transmit, to the at least one additional edge repository, associated with the at least one additional operator, the first information.

3. The apparatus of claim 2, wherein the first information is associated with a set of partner ECSs, and wherein the first information is transmitted to the at least one first additional edge repository based on the at least one first ECS being included in the set of partner ECSs.

4. The apparatus of claim 2, wherein the first information is associated with a set of partner operators, and wherein the first information is transmitted to the at least one additional edge repository based on the at least one additional edge repository being associated with at least one operator included in the set of partner operators.

5. The apparatus of claim 2, wherein, to transmit the first information, the one or more processors are configured to:
receive a discovery request, from the at least one additional edge repository, associated with the at least one additional operator; and
transmit the first information.

6. The apparatus of claim 1, wherein, to receive the first information, the one or more processors are configured to:
receive a registration request, from the at least one first ECS, that includes the first information; and
store the first information.

7. The apparatus of claim 6, wherein the one or more processors are further configured to:
receive a registration update request, from the at least one first ECS; and
update the first information based on the registration update request.

8. The apparatus of claim 6, wherein the one or more processors are further configured to:
receive a de-registration request, from the at least one first ECS; and
remove the first information.

9. The apparatus of claim 6, wherein the one or more processors are further configured to:
remove the first information based on not receiving a registration update request before an expiry time associated with the registration request.

10. The apparatus of claim 1, wherein, to receive the second information, the one or more processors are configured to:
transmit, to the at least one additional edge repository, associated with the at least one additional operator, a discovery request associated with the second information;
receive the second information from the at least one additional edge repository, associated with the at least one additional operator; and
store the second information.

11. The apparatus of claim 1, wherein, to transmit the first information, the second information or a combination thereof, the one or more processors are configured to:
receive a discovery request, from at least one first ECS, associated with the first information; and
transmit the first information, the second information or a combination thereof.

12. An apparatus for communication at an edge configuration server (ECS), comprising:
a memory; and
one or more processors, coupled to the memory, configured to:
transmit, to an edge repository associated with an operator, a registration request including information associated with edge computing resources associated with the ECS; and
receive, from the edge repository, a response to the registration request.

13. The apparatus of claim 12, wherein the one or more processors are further configured to:
transmit, to the edge repository, a registration update request; and
receive, from the edge repository, a response to the registration update request.

14. The apparatus of claim 12, wherein the one or more processors are further configured to:
transmit, to the edge repository, a de-registration request; and
receive, from the edge repository, a response to the de-registration request.

15. The apparatus of claim 12, wherein the registration request is transmitted based on an address of the edge repository stored in the memory.

16. The apparatus of claim 12, wherein the registration request includes configuration information and credentials associated with the ECS.

17. The apparatus of claim 12, wherein the registration request indicates a set of partner ECSs, a set of partner operators, or a combination thereof.

18. The apparatus of claim 12, wherein the response indicates an expiry time, and wherein the one or more processors are further configured to:
transmit, to the edge repository, a registration update request before the expiry time.

19. The apparatus of claim 12, wherein the ECS is a primary ECS, and wherein the one or more processors are further configured to:
receive, from an edge enabler client (EEC), a service provisioning request; and
transmit, to the EEC, information associated with edge computing resources associated with one or more applications indicated by the service provisioning request.

20. The apparatus of claim 19, wherein the one or more processors are further configured to:
transmit, to the edge repository, a discovery request based on the service provisioning request; and
receive, from the edge repository, a discovery response associated with one or more partner ECSs, wherein the information associated with the edge computing resources, associated with the one or more applications, indicates the one or more partner ECSs.

21. The apparatus of claim 12, wherein the ECS is a primary ECS, and wherein the one or more processors are further configured to:
receive, from an edge enabler client (EEC), a proxy service provisioning request; and
transmit, to the EEC, information associated with an edge data network (EDN) providing edge computing resources associated with one or more applications indicated by the service provisioning request.

22. The apparatus of claim 21, wherein the proxy service provisioning request includes credentials associated with the EEC.

23. The apparatus of claim 22, wherein the one or more processors are further configured to:
authorize the EEC based on the credentials,
wherein the information associated with the EDN is transmitted based on authorizing the EEC.

24. The apparatus of claim 21, wherein the one or more processors are further configured to:
transmit, to a partner ECS, a relayed service provisioning request based on the proxy service provisioning request; and
receive, from the partner ECS, a relayed service provisioning response associated with the EDN providing the edge computing resources associated with the one or more applications.

25. An apparatus for communication at an edge enabler client (EEC), comprising:
a memory; and
one or more processors, coupled to the memory, configured to:
transmit, to a primary edge configuration server (ECS), a service provisioning request; and
receive, from the primary ECS, information associated with one or more partner ECSs associated with one or more applications indicated by the service provisioning request.

26. The apparatus of claim 25, wherein the service provisioning request includes credentials associated with the EEC.

27. The apparatus of claim 25, wherein the one or more processors are further configured to:
transmit, to the primary ECS, a proxy service provisioning request; and
receive, from the primary ECS, information associated with an edge data network (EDN) providing edge computing resources associated with one or more applications indicated by the service provisioning request.

28. A method of wireless communication performed by an edge repository, comprising:
receiving, from at least one first edge configuration server (ECS) associated with an operator of the edge repository, first information associated with edge computing resources associated with the at least one first ECS;
receiving, from at least one additional edge repository, associated with at least one additional operator, second information associated with edge computing resources associated with at least one second ECS; and
transmitting, to the at least one first ECS, the first information, the second information, or a combination thereof.

29. The method of claim 28, further comprising:
receiving a discovery request, from the at least one additional edge repository, associated with the at least one additional operator; and
transmitting, to the at least one additional edge repository, associated with the at least one additional operator, the first information.

30. The method of claim 28, wherein receiving the second information comprises:
transmitting, to the at least one additional edge repository, associated with the at least one additional operator, a discovery request associated with the second information;
receiving the second information from the at least one additional edge repository, associated with the at least one additional operator; and
storing the second information.
